(19) United States
(12) Patent Application Publication
(10) Pub. No.: US 2024/0157549 A1
(43) Pub. Date: May 16, 2024

(54) ROBOT CONTROL METHOD, ROBOT AND STORAGE MEDIUM

(71) Applicant: HAI ROBOTICS CO., LTD., Shenzhen (CN)

(72) Inventor: Han LIN, Shenzhen (CN)

(21) Appl. No.: 18/418,464

(22) Filed: Jan. 22, 2024

Related U.S. Application Data
(63) Continuation of application No. PCT/CN2022/107508, filed on Jul. 22, 2022.

(30) Foreign Application Priority Data
Jul. 30, 2021 (CN) 202110874389.2

(51) Int. Cl. B25J 9/16; B25J 13/08

(52) U.S. Cl. CPC B25J 9/162; B25J 9/1666; B25J 9/1697; B25J 13/089

(57) ABSTRACT

This application provides a robot control method, a robot and a storage medium. According to the method, a current operating mode of the robot is determined, and then a control instruction corresponding to the operating mode is determined based on detection data obtained by a detection sensor arranged on a manipulator mechanism of the robot, so as to control the robot. In this way, the detection data obtaining function in various operating modes can be realized through one set of detection sensors, which not only can reduce the cost of materials for the robot, but also can save space in the robot for arrangement of sensors and wires.

### CROSS-REFERENCES

This application is a continuation of International Patent Application No. PCT/CN2022/107508 filed on Jul. 22, 2022, which claims priority to Chinese Patent Application No. 202110874389.2, filed with the China National Intellectual Property Administration on Jul. 30, 2021 and entitled “ROBOT CONTROL METHOD AND APPARATUS, ROBOT, STORAGE MEDIUM, AND PROGRAM PRODUCT”, which is incorporated herein by reference in its entirety.

### BACKGROUND OF THE INVENTION

With the increasingly extensive application of logistics and warehousing automation, a number of warehouses using automated case-handling mobile robots for warehousing management grows rapidly.

The automated case-handling mobile robot needs to use an external sensor to obtain environmental information, which is used to calculate a position and obstacle avoidance of the automated case-handling mobile robot in the warehouse, and also needs the external sensor to obtain information of a robot operation target, which is used to identify and locate the operation target.

It can be seen that in order to realize the above two functions, it is usually necessary to configure two sets of sensors for implementation, which needs relatively high implementation costs.

### SUMMARY OF THE INVENTION

This application provides a robot control method and apparatus, a robot, a storage medium, and a program product, so as to solve the problem of high costs during respective implementation of functions through two sets of sensors in the prior art.

According to a first aspect, this application provides a robot control method. The robot control method is applicable to a robot. The robot includes a robot body and a manipulator mechanism arranged on the robot body, the manipulator mechanism is configured to transport a target object, and a detection sensor is arranged on the manipulator mechanism. The method includes:
determining a current operating mode of the robot, where the operating mode includes a movement mode and an interaction mode, and the robot is configured to move according to a target path in the movement mode and locates the target object in the interaction mode; determining a control instruction corresponding to the operating mode based on detection data obtained by the detection sensor; and controlling the robot based on the control instruction.

In a possible design, the determining a control instruction corresponding to the operating mode based on detection data obtained by the detection sensor includes:
determining an obstacle object on the target path based on the detection data if the current operating mode of the robot is the movement mode, where the control instruction is used to control the robot to avoid the obstacle object; or
determining pose position information of the target object based on the detection data if the current operating mode of the robot is the interaction mode, where the control instruction is used to control the robot to take or place the target object.

In a possible design, if the current operating mode of the robot is the movement mode, the method further includes:
controlling a detection direction of the detection sensor on the robot to be directed at a current movement direction of the robot.

In a possible design, after the controlling a detection direction of the detection sensor on the robot to be directed at a current movement direction of the robot, the method further includes:
determining whether the detection direction of the detection sensor is blocked by the robot body; and
adjusting the detection direction of the detection sensor if the detection direction is blocked, so that the adjusted detection direction is not blocked by the robot body.

In a possible design, if the current operating mode of the robot is the interaction mode, the method further includes:
controlling a detection direction of the detection sensor on the robot so that scanning is performed within a preset angle range; and
determining, based on a detection result after the scanning, that the detection direction of the detection sensor is directed at the target object.

In a possible design, the determining a control instruction corresponding to the operating mode based on detection data obtained by the detection sensor includes:
determining pose position information of the target object based on the detection data if the current operating mode of the robot is the interaction mode, where the target object is a charging pile;
switching the current operating mode of the robot to the movement mode; and
adjusting a pose of the robot based on the pose position information in the movement mode, so that the robot is connected to the charging pile for charging.

In a possible design, the manipulator mechanism includes a support, a tray, and a telescopic arm, where the tray is located in the support, the tray is configured for the target object to be placed, the telescopic arm is located on the support, and the telescopic arm is configured to push the target object placed on the tray out of the tray or pull the target object onto the tray; and
the detection sensor is arranged below the tray, and is configured to obtain image information of a target position within different image capturing ranges, and the target position includes a position on the target path corresponding to the robot in the movement mode and a taking or placing position of the target object in the interaction mode.

In a possible design, a photographing direction of the detection sensor is the same as a direction of stretching or retracting of the telescopic arm.

In a possible design, the detection sensor is one or more of a visual sensor, an optical sensor, and an acoustic sensor.

According to a second aspect, this application provides a robot control apparatus, including:
an obtaining module, configured to determine a current operating mode of a robot, where the operating mode includes a movement mode and an interaction mode, and the robot is configured to move according to a target path in the movement mode and locates a target object in the interaction mode;
a determining module, configured to determine a control instruction corresponding to the operating mode based on detection data obtained by a detection sensor, where the detection sensor is arranged on a manipulator mechanism of the robot; and
a control module, configured to control the robot based on the control instruction.

In a possible design, the determining module is specifically configured to: determine an obstacle object on the target path based on the detection data if the current operating mode of the robot is the movement mode, where the control instruction is used to control the robot to avoid the obstacle object; or
determine pose position information of the target object based on the detection data if the current operating mode of the robot is the interaction mode, where the control instruction is used to control the robot to take or place the target object.

In a possible design, the control module is further configured to control a detection direction of the detection sensor on the robot to be directed at a current movement direction of the robot.

In a possible design, the determining module is further configured to determine whether the detection direction of the detection sensor is blocked by the robot body.

The control module is further configured to adjust the detection direction of the detection sensor, so that the adjusted detection direction is not blocked by the robot body.

In a possible design, the control module is further configured to control a detection direction of the detection sensor on the robot so that scanning is performed within a preset angle range.

In a possible design, the control module is further configured to determine, based on a detection result after the scanning, that the detection direction of the detection sensor is directed at the target object.

In a possible design, the determining module is specifically configured to:
determine pose position information of the target object based on the detection data if the current operating mode of the robot is the interaction mode, where the target object is a charging pile;
switch the current operating mode of the robot to the movement mode; and
adjust a pose of the robot based on the pose position information in the movement mode, so that the robot is connected to the charging pile for charging.

In a possible design, the manipulator mechanism includes a support, a tray, and a telescopic arm, where the tray is located in the support, the tray is configured for the target object to be placed, the telescopic arm is located on the support, and the telescopic arm is configured to push the target object placed on the tray out of the tray or pull the target object onto the tray;
the detection sensor is arranged below the tray, and is configured to obtain image information of a target position within different image capturing ranges, and the target position includes a position on the target path corresponding to the robot in the movement mode and a taking or placing position of the target object in the interaction mode.

In a possible design, a photographing direction of the detection sensor is the same as a direction of stretching or retracting of the telescopic arm.

In a possible design, the detection sensor is one or more of a visual sensor, an optical sensor, and an acoustic sensor.

According to a third aspect, this application provides a robot, including: a robot body, a manipulator mechanism arranged on the robot body, a memory, and at least one processor, where
the manipulator mechanism is configured to transport a target object, and a detection sensor is arranged on the manipulator mechanism;
the memory is configured to store computer-executable instructions; and
the at least one processor executes the computer-executable instructions stored in the memory, so that the at least one processor performs the robot control method according to the first aspect and various possible designs of the first aspect.

According to a fourth aspect, an embodiment of this application provides a computer-readable storage medium. The computer-readable storage medium stores computer-executable instructions, and when a processor executes the computer-executable instructions, the robot control method according to the first aspect and various possible designs of the first aspect is implemented.

According to a fifth aspect, an embodiment of this application provides a computer program product, including a computer program. When the computer program is executed by a processor, the robot control method according to the first aspect and various possible designs of the first aspect is implemented.

According to the robot control method and apparatus, the robot, the storage medium, and the program product provided in this application, a current operating mode of the robot is determined, and then a control instruction corresponding to the operating mode is determined based on detection data obtained by a detection sensor arranged on a manipulator mechanism of the robot, so as to control the robot. In this way, the detection data obtaining function in various operating modes can be realized through only one set of detection sensors, which not only can reduce the cost of materials for the robot, but also can save space in the robot for arrangement of sensors and wires. Furthermore, in the operating process of the robot, the switching is realized by using one set of detection sensors, which can not only satisfy the requirement of collecting environmental information through the detection sensors in the movement mode, so that the robot can realize the obstacle avoidance function in the movement mode, but also satisfy the requirement of collecting target object information through the detection sensors in the interaction mode, so that the robot can realize the function of taking or placing targets in the interaction mode.

### TECHNICAL FIELD

This application relates to the technical field of intelligent warehousing, and in particular, to a robot control method and apparatus, a robot, a storage medium, and a program product.

### BRIEF DESCRIPTION OF DRAWINGS

Accompanying drawings herein are incorporated into the specification and constitute a part of this specification, show embodiments that conform to this application, and are used for explaining the principle of this application together with this specification.

FIG. 1 is a schematic structural diagram of a robot according to an embodiment of the present disclosure;

FIG. 2 is a diagram of a use state of a robot according to an embodiment of the present disclosure;

FIG. 3 is a schematic structural diagram of a manipulator mechanism in a robot according to an embodiment of the present disclosure;

FIG. 4 is a schematic structural diagram of a manipulator mechanism in a robot according to an embodiment of the present disclosure from another perspective;

FIG. 5 is a front view of a manipulator mechanism in a robot according to an embodiment of the present disclosure;

FIG. 6 is a schematic flowchart of a robot control method according to an example embodiment of this application;

FIG. 7 is a schematic flowchart of a robot control method according to another example embodiment of this application;

FIG. 8 is a schematic flowchart of a robot control method according to still another example embodiment of this application;

FIG. 9 is a schematic flowchart of a robot control method according to yet another example embodiment of this application;

FIG. 10 is a schematic flowchart of a robot control apparatus according to an example embodiment of this application; and

FIG. 11 is a schematic structural diagram of a robot according to another example embodiment of this application.

Specific embodiments of this application are shown in the above accompanying drawings, which are to be described in more detail later. These accompanying drawings and text description are not intended to limit the scope of the concept of this application in any way, but to describe the concept of this application for those skilled in the art with reference to specific embodiments.

### DETAILED DESCRIPTION

Exemplary embodiments are to be described herein in detail, and examples of the exemplary embodiments are shown in the accompanying drawings. When the following description involves the accompanying drawings, unless otherwise indicated, the same numerals in different accompanying drawings represent the same or similar elements. Implementations described in the following exemplary embodiments do not represent all implementations consistent with this application. On the contrary, the implementations are merely examples of an apparatus and a method which are consistent with some aspects of this application described in detail in the attached claims.

The technical solutions of the present disclosure and how the technical solutions of the present disclosure resolve the above technical problems are described in detail below through the specific embodiments. The following several specific embodiments may be combined with each other, and the same or similar concepts or processes may not be described repeatedly in some embodiments. The embodiments of the present disclosure are described below with reference to the accompanying drawings.

In the prior art, a automated case-handling mobile robot needs to use an external sensor to obtain environmental information, which is used to calculate a position and obstacle avoidance of the automated case-handling mobile robot in the warehouse, and also needs the external sensor to obtain information of a robot operation target, which is used to identify and locate the operation target. In order to realize the above two functions, it is usually necessary to set two sets of sensors, one configured for chassis positioning and obstacle avoidance, and the other configured for positioning of a target object. The sensor configured for positioning and obstacle avoidance is usually arranged on a robot chassis, and the sensor configured for positioning of a target object is usually arranged at another position.

It can be seen that in order to realize the above two functions, it is usually necessary to configure two sets of sensors for implementation in the prior art, which needs relatively high implementation costs.

Based on the above technical problem, this application is intended to provide a robot control method and apparatus, a robot, a storage medium, and a program product. A current operating mode of the robot is determined, and then a control instruction corresponding to the operating mode is determined based on detection data obtained by a detection sensor arranged on a manipulator mechanism of the robot, so as to control the robot. In this way, the detection data obtaining function in various operating modes can be realized through only one set of detection sensors, which not only can reduce the cost of materials for the robot, but also can save space in the robot for arrangement of sensors and wires. Furthermore, in the operating process of the robot, the switching is realized by using one set of detection sensors, which can not only satisfy the requirement of collecting environmental information through the detection sensors in the movement mode, so that the robot can realize the obstacle avoidance function in the movement mode, but also satisfy the requirement of collecting target object information through the detection sensors in the interaction mode, so that the robot can realize the function of taking or placing targets in the interaction mode.

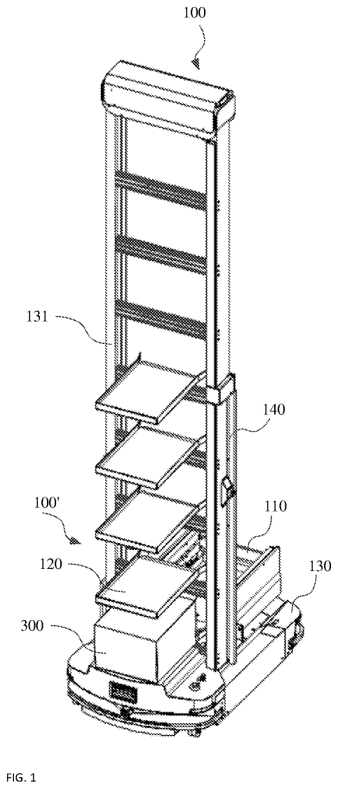

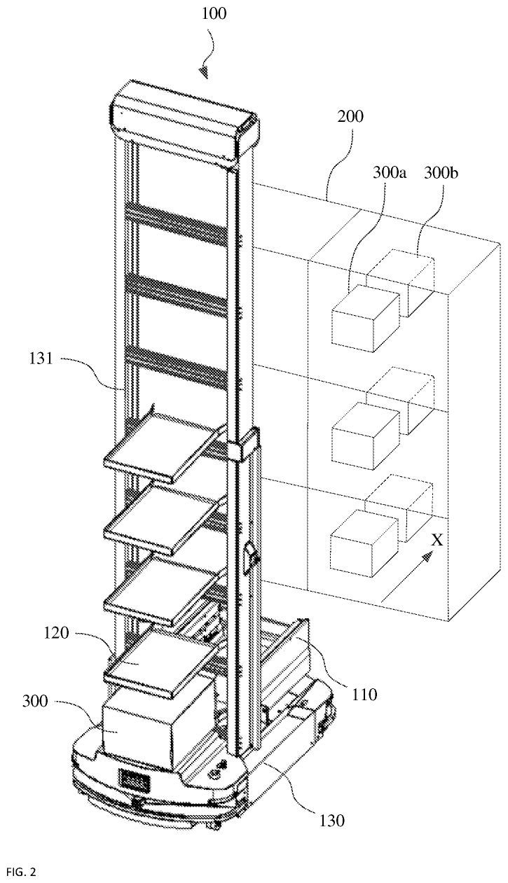

FIG. 1 is a schematic structural diagram of a robot according to an embodiment of the present disclosure. FIG. 2 is a diagram of a use state of a robot according to an embodiment of the present disclosure. Referring to FIG. 1 and FIG. 2, the present disclosure provides a robot 100 configured to transport goods 300 on a warehouse shelving unit 200.

The robot 100 may be applied to an intelligent warehousing system, an intelligent logistics system, an intelligent sorting system, and the like. In this embodiment, the application of the robot 100 to the intelligent warehousing system is used as an example for description.

Specifically, the warehouse shelving unit 200 may be arranged to have a single layer or a plurality of layers, and a number of warehouse shelving units 200 may be one or more. Any layer of the warehouse shelving unit 200 is configured for a target object to be placed. The target object may be the goods 300, and at least one piece of goods is placed in a depth direction of the warehouse shelving unit 200. The depth direction (an X direction in FIG. 2) of the warehouse shelving unit 200 is the same as a taking or placing direction of the goods 300.

The robot 100 may include a body 100′ and a manipulator mechanism 110. The body 100′ includes a storage rack 120 and a mobile chassis 130, and the manipulator mechanism 110 is configured to carry the goods 300 to the storage rack 120 or carry out the goods 300 from the storage rack 120. The mobile chassis 130 is configured to bear the storage rack 120 and the manipulator mechanism 110.

The storage rack 120 is configured for the goods 300 to be stored. A plurality of layers of storage racks 120 may be arranged. A support frame 131 is arranged on the mobile chassis 130. The support frame 131 extends toward the top of the mobile chassis 130. The storage racks 120 may be evenly spaced in an extending direction of the support frame 131, and the storage racks 120 are connected to the support frame 131.

The body 100′ may further include a lifting or lowering assembly 140. The lifting or lowering assembly 140 is mounted to the mobile chassis 130. The lifting or lowering assembly 140 is connected to the manipulator mechanism 110, and the lifting or lowering assembly 140 is configured to drive the manipulator mechanism 110 to ascend or descend. The lifting or lowering assembly 140 may include a driving member (e.g., a motor) and a transmission mechanism. Power is provided by the driving member and transmitted by the transmission mechanism to lift and lower the manipulator mechanism 110. The transmission mechanism may be a chain wheel mechanism, a screw mechanism, a belt wheel mechanism, or a transmission mechanism well known to a person skilled in the art, which is not limited herein in this embodiment.

The manipulator mechanism 110 is configured to carry the goods 300 between the storage rack 120 and the warehouse shelving unit 200. The manipulator mechanism 110 is driven to ascend or descend through the lifting or lowering assembly 140, so that the manipulator mechanism 110 can carry the goods 300 on any one of the plurality of layers of storage racks 120 or any layer of the warehouse shelving unit 200.

It may be understood that the manipulator mechanism 110 is not limited to application to the robot 100. For example, the manipulator mechanism 110 may further be applied to fields such as a shuttle vehicle and a sorting platform, which is not limited herein in this embodiment.

In addition, the robot 100 may further move in the intelligent warehousing system by moving the chassis 130 to move to different storage racks 120 to store and take out goods.

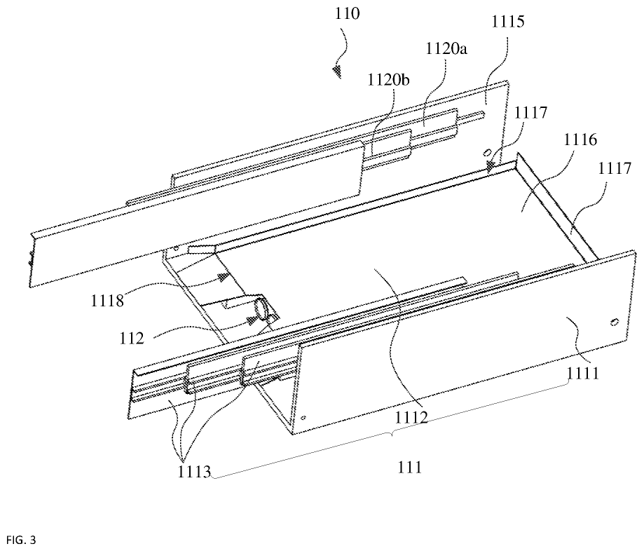

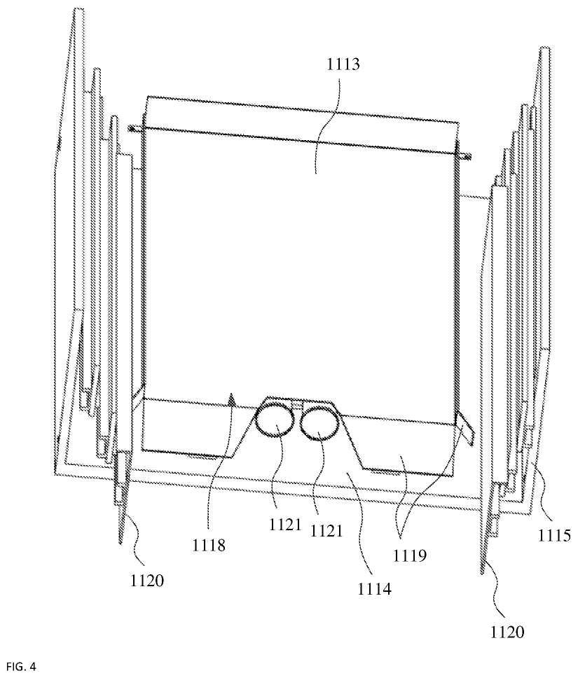

FIG. 3 is a schematic structural diagram of a manipulator mechanism in a robot according to an embodiment of the present disclosure. FIG. 4 is a schematic structural diagram of a manipulator mechanism in a robot according to an embodiment of the present disclosure from another perspective. FIG. 5 is a front view of a manipulator mechanism in a robot according to an embodiment of the present disclosure. Referring to FIG. 3 to FIG. 5, a detection assembly 112 is arranged on a manipulator mechanism 110 provided in the present disclosure. The manipulator mechanism may be a fork 111.

Specifically, the fork 111 includes a support 1111, a tray 1112, and a telescopic arm 1113. The tray 1112 is located in the support 1111, the tray 1112 is configured for goods 300 to be placed, the telescopic arm 1113 is located on the support 1111, and the telescopic arm 1113 is configured to push the goods 300 placed on the tray 1112 out of the tray 1112 or pull the goods 300 onto the tray 1112.

The detection assembly 112 is arranged below the tray 1112, and the detection assembly 112 includes at least two detection sensors 1121 arranged at intervals. The detection sensors 1121 may be two units arranged at intervals, and each of the detection sensors 1121 is configured to obtain image information of a target position in different image capturing ranges. The target position includes a position on a target path corresponding to a robot 100 in a movement mode and a taking or placing position of the goods 300 in an interaction mode.

Specifically, the support 1111 may be in the shape of a groove with openings at two ends. During specific implementation, the support 1111 may include a bottom plate 1114 and first side plates 1115 located at two opposite sides of the bottom plate 1114. The side plates 1115 may be perpendicular to the bottom plate 1114. The support 1111 may be formed by welding, bending, or stamping a steel plate.

The tray 1112 may be arranged in the support 1111, and the tray 1112 may be connected to an inner surface of the bottom plate 1114 or an inner side surface of the first side plate 1115. The goods 300 are placed through the tray 1112. The tray 1112 may include a bearing plate 1116 and a second side plate 1117 surrounding at least one side of the bearing plate 1116. A side of the bearing plate 1116 has an opening 1118, that is, the side of the bearing plate 1116 is not provided with the second side plate 1117 to form the opening 1118. The goods 300 enter the tray 1112 through the opening 1118 and are borne on the bearing plate 1116. The second side plate 1117 is arranged on a peripheral side of the bearing plate 1116, to prevent the goods 300 from moving out of the tray 1112.

It should be noted that, the second side plate 1117 may be arranged only on an opposite side of the opening 1118, to prevent the goods 300 from moving out of the tray 1112. Alternatively, only the opening 1118 is not provided with the second side plate 1117, and the remaining sides of the bearing plate 1116 are provided with the second side plate 1117. When the goods 300 enter the tray 1112 through the opening 1118, the goods are more likely to be moved out of the tray 1112 through the second side plate 1117 arranged on a side opposite to the opening 1118. Therefore, a height of the second side plate 1117 arranged on the opposite side of the opening 1118 may be greater than a height of the remaining second side plates 1117.

In order to facilitate smooth entry of the goods 300 into the tray 1112, an end of the bearing plate 1116 and an end of the second side plate 1117 facing the opening 1118 may be each provided with a guide edge 1119, and a size of the opening 1118 can be increased through the guide edge 1119. For example, the guide edge 1119 of the second side plate 1117 adjacent to the opening 1118 may extend toward outside of the tray 1112, and the guide edge 1119 at the end of the bearing plate 1116 may extend toward the bottom plate 1114.

During specific implementation, a number of telescopic arms 1113 may be one or more. In the accompanying drawings of this embodiment, the number of telescopic arms 1113 is two by way of example for description. The two telescopic arms 1113 are respectively located on the two first side plates 1115. The telescopic arms 1113 may be both located on an inner side wall or an outer side wall of the first side plate 1115. At least one of the two telescopic arms 1113 is located on the inner side wall of one first side plate 1115, and the other is located on the outer side wall of the other first side plate 1115, which is not limited herein in this embodiment.

Each of the telescopic arms 1113 may include at least two arm sections 1120 nested with each other and at least one arm section driving assembly (not shown). An outer arm section 1120a is connected to the first side plate 1115, and the arm section driving assembly is configured to drive an inner arm section 1120b, so that the inner arm section 1120b moves relative to the outer arm section 1120a. The arm section driving assembly may be a driving assembly such as a chain wheel mechanism, a belt wheel mechanism, a hydraulic driving mechanism, or a linear motor well known to a person skilled in the art, which is not limited herein in this embodiment. In addition, it is to be noted that a photographing direction of the detection sensor 1121 described above is the same as a direction of stretching or retracting of the telescopic arm 1113.

In addition, the detection sensor 1121 described above may be one or more of a visual sensor, an optical sensor, and an acoustic sensor, which may specifically be a 2D camera, a 3D camera, a laser radar, a laser range finder, and a sonar.

FIG. 6 is a schematic flowchart of a robot control method according to an example embodiment of this application. As shown in FIG. 6, the robot control method provided in this embodiment includes the following steps.

Step 101: Determine a current operating mode of a robot.

During operation of the robot, the current operating mode of the robot may be determined based on operating state information of the robot, where the operating mode may include a movement mode and an interaction mode.

Specifically, in the movement mode, the robot is configured to move according to a target path. It may be understood that in the mode, the whole chassis of the robot is in a moving state and needs to move from one position to another position in a warehousing system.

However, in the interaction mode, the robot locates a target object and performs some operation or detection on the target object. For example, the robot needs to locate a target goods box on a shelving unit, and then take or place the target goods box.

Step 102: Determine a control instruction corresponding to the operating mode based on detection data obtained by a detection sensor.

After the current operating mode of the robot is determined, the control instruction corresponding to the operating mode may be determined based on the detection data obtained by the detection sensor.

When the determined operating mode is the movement mode, an obstacle object on the target path is determined based on the detection data. The control instruction is used to control the robot to avoid the obstacle object. It is to be noted that when the robot chassis is to move to another place, and the robot is in the movement mode in this case, a manipulator mechanism is moved to direct a detection range of the detection sensor at the environment to collect as much environmental information as possible. The above detection data is environmental information collected by the detection sensor. However, the control instruction is an obstacle avoidance instruction executed based on the analysis of the environmental information collected by the detection sensor, so that the robot can realize the obstacle avoidance function in the movement mode.

However, when the determined operating mode is the interaction mode, pose position information of the target object is determined based on the detection data. The control instruction is used to control the robot to take or place the target object. It is to be noted that when the robot wants to use the manipulator mechanism to interact with an operating target, the manipulator mechanism is moved to direct the detection range of the detection sensor at the operating target to collect as much target object information as possible. However, the control instruction is a goods retrieval or storage instruction executed based on the analysis of the target object information collected by the detection sensor, so that the robot can realize the goods retrieval or storage function in the interaction mode.

The detection sensor may be a laser radar by way of example for description. Specifically, the manipulator mechanism of the robot is equipped with a laser radar. In the movement mode, the laser radar is directed at the front of the movement direction of the robot, so that the laser radar is not blocked by the mechanism thereof as much as possible, and environmental information is collected for simultaneous localization and mapping (Simultaneous Localization And Mapping, SLAM) or another form of positioning and obstacle avoidance. In the interaction mode, the laser radar is directed at the target object, so as to detect whether the target object exists and calculate a position and a pose of the target object.

The detection sensor may further be a 2D camera or a 3D camera by way of example for description Specifically, the manipulator mechanism of the robot is equipped with a 2D camera or a 3D camera. In the movement mode, the camera is directed at the front of the movement direction of the robot, so that the camera is not blocked by the mechanism thereof as much as possible, and environmental information is collected for functions such as visual SLAM, human body recognition, obstacle avoidance, and following. In the interaction mode, the camera is directed at the target object, so as to search and detect the target object and calculate a position and a pose of the target object.

Step 103: Control the robot based on the control instruction.

Finally, the robot is controlled based on the determined control instruction. When the operating mode is interaction mode, the determined control instruction is used to control the robot to take or place the target object, and when the operating mode is the movement mode, the determined control instruction is used to enable the robot to realize the obstacle avoidance function in the movement mode.

In this embodiment, the current operating mode of the robot is determined, and then the control instruction corresponding to the operating mode is determined based on the detection data obtained by the detection sensor arranged on the manipulator mechanism of the robot, so as to control the robot. In this way, the detection data obtaining function in various operating modes can be realized through only one set of detection sensors, which not only can reduce the cost of materials for the robot, but also can save space in the robot for arrangement of sensors and wires. Furthermore, in the operating process of the robot, the switching is realized by using one set of detection sensors, which can not only satisfy the requirement of collecting environmental information through the detection sensors in the movement mode, so that the robot can realize the obstacle avoidance function in the movement mode, but also satisfy the requirement of collecting target object information through the detection sensors in the interaction mode, so that the robot can realize the function of taking or placing targets in the interaction mode.

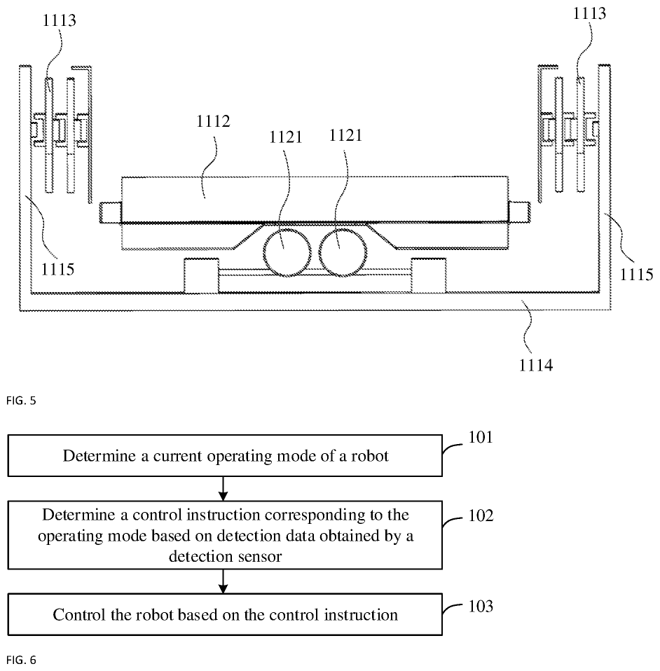

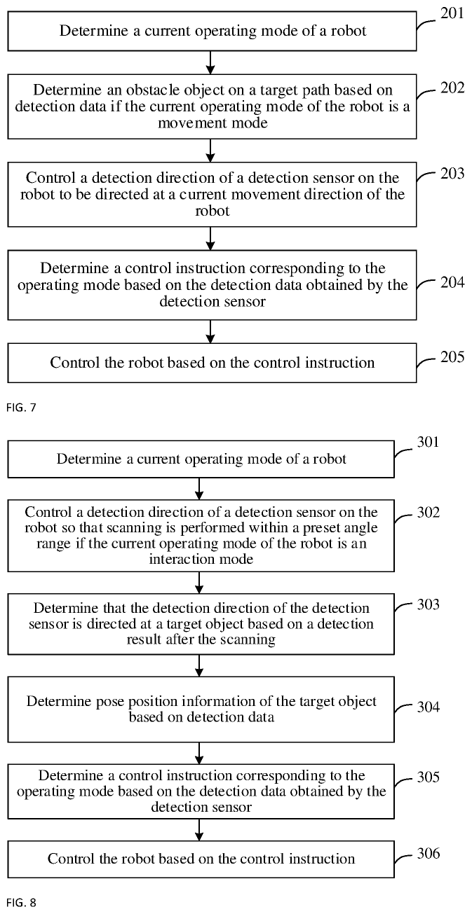

FIG. 7 is a schematic flowchart of a robot control method according to another example embodiment of this application. As shown in FIG. 7, the robot control method provided in this embodiment includes the following steps.

Step 201: Determine a current operating mode of a robot.

During operation of the robot, the current operating mode of the robot may be determined based on operating state information of the robot, where the operating mode may include a movement mode and an interaction mode.

Specifically, in the movement mode, the robot is configured to move according to a target path. It may be understood that in the mode, the whole chassis of the robot is in a moving state and needs to move from one position to another position in a warehousing system.

However, in the interaction mode, the robot locates a target object and performs some operation or detection on the target object. For example, the robot needs to locate a target goods box on a shelving unit, and then take or place the target goods box.

Step 202: Determine an obstacle object on a target path based on detection data if the current operating mode of the robot is a movement mode.

When the determined operating mode is the movement mode, the obstacle object on the target path is determined based on the detection data, so as to realize the obstacle avoidance function based on the determined position of the obstacle object.

Step 203: Control a detection direction of a detection sensor on the robot to be directed at a current movement direction of the robot.

In the movement mode, in order to enable the robot to accurately identify obstacles on the driving path, the detection direction of the detection sensor on the robot may be controlled to be directed at the current movement direction of the robot.

Optionally, after the detection direction of the detection sensor on the robot is controlled to be directed at the current movement direction of the robot, it may further be determined whether the detection direction of the detection sensor is blocked by the robot body. If the detection direction of the detection sensor is blocked by the robot body, the detection direction of the detection sensor is adjusted, so that the adjusted detection direction is not blocked by the robot body, thereby ensuring that the detection sensor on the robot can better obtain external environmental data.

Step 204: Determine a control instruction corresponding to the operating mode based on the detection data obtained by the detection sensor.

When the determined operating mode is the movement mode, an obstacle object on the target path is determined based on the detection data. The control instruction is used to control the robot to avoid the obstacle object. It is to be noted that when the robot chassis is to move to another place, and the robot is in the movement mode in this case, a manipulator mechanism is moved to direct a detection range of the detection sensor at the environment to collect as much environmental information as possible. The above detection data is environmental information collected by the detection sensor. The control instruction is an obstacle avoidance instruction executed based on the analysis of the environmental information collected by the detection sensor, so that the robot can realize the obstacle avoidance function in the movement mode.

Step 205: Control the robot based on the control instruction.

Finally, when the operating mode is the movement mode, the obstacle avoidance function of the robot is realized based on the determined control instruction.

FIG. 8 is a schematic flowchart of a robot control method according to still another example embodiment of this application. As shown in FIG. 8, the robot control method provided in this embodiment includes the following steps.

Step 301: Determine a current operating mode of a robot.

During operation of the robot, the current operating mode of the robot may be determined based on operating state information of the robot, where the operating mode may include a movement mode and an interaction mode.

Specifically, in the movement mode, the robot is configured to move according to a target path. It may be understood that in the mode, the whole chassis of the robot is in a moving state and needs to move from one position to another position in a warehousing system.

However, in the interaction mode, the robot locates a target object and performs some operation or detection on the target object. For example, the robot needs to locate a target goods box on a shelving unit, and then take or place the target goods box.

Step 302: Control a detection direction of a detection sensor on the robot so that scanning is performed within a preset angle range if the current operating mode of the robot is an interaction mode.

When the determined operating mode is the interaction mode, the detection direction of the detection sensor on the robot is controlled so that scanning is performed within the preset angle range, to determine a direction of the target object.

Step 303: Determine that the detection direction of the detection sensor is directed at the target object based on a detection result after the scanning.

After the direction of the target object is determined through detection data, the detection direction of the detection sensor is controlled to be directed at the target object, so that the data can be updated in real time during subsequent taking or placing of the target object.

Step 304: Determine pose position information of a target object based on detection data.

In this step, the pose position information of the target object is determined based on the obtained detection data, so that the target object can be taken or placed subsequently.

Step 305: Determine a control instruction corresponding to the operating mode based on detection data obtained by a detection sensor.

The pose position information of the target object is determined based on the detection data. The control instruction is used to control the robot to take or place the target object. It is to be noted that when the robot wants to use the manipulator mechanism to interact with an operating target, the manipulator mechanism is moved to direct the detection range of the detection sensor at the operating target to collect as much target object information as possible. The control instruction is a goods retrieval or storage instruction executed based on the analysis of the target object information collected by the detection sensor, so that the robot can realize the goods retrieval or storage function in the interaction mode.

Step 306: Control the robot based on the control instruction.

Finally, in the interaction mode, the robot is controlled based on the control instruction, so as to realize the function of taking or placing the target object by the robot.

FIG. 9 is a schematic flowchart of a robot control method according to yet another example embodiment of this application. As shown in FIG. 9, the robot control method provided in this embodiment includes the following steps.

Step 401: Determine a current operating mode of a robot.

During operation of the robot, the current operating mode of the robot may be determined based on operating state information of the robot, where the operating mode may include a movement mode and an interaction mode.

Specifically, in the movement mode, the robot is configured to move according to a target path. It may be understood that in the mode, the whole chassis of the robot is in a moving state and needs to move from one position to another position in a warehousing system.

However, in the interaction mode, the robot locates a target object and performs some operation or detection on the target object. For example, the robot needs to locate a target goods box on a shelving unit, and then take or place the target goods box.

Step 402: Determine pose position information of a target object based on detection data if the current operating mode of the robot is an interaction mode, where the target object is a charging pile.

When the current operating mode of the robot is the interaction mode, and it is necessary to charge the robot in the interaction mode, the pose position information of the charging pile is determined based on the detection data.

Step 403: Switch the current operating mode of the robot to a movement mode.

Then, after the pose position information of the charging pile is determined, the current operating mode of the robot is switched to the movement mode, so that the robot can move based on the pose position information of the charging pile, and then a charging interface of the robot is connected to a charging structure of the charging pile.

Step 404: Adjust a pose of the robot based on the pose position information in the movement mode, so that the robot is connected to the charging pile for charging.

Specifically, in the movement mode, the pose of the robot is adjusted based on the pose position information, so that the robot is connected to the charging pile for charging.

In this way, when the robot needs to be charged, the pose position information of the charging pile is determined through the detection sensor in the interaction mode, and then through switching to the movement mode, the external environment data is continuously obtained through the detection sensor, and the pose of the robot is adjusted, so that the robot can be connected to the charging pile for charging.

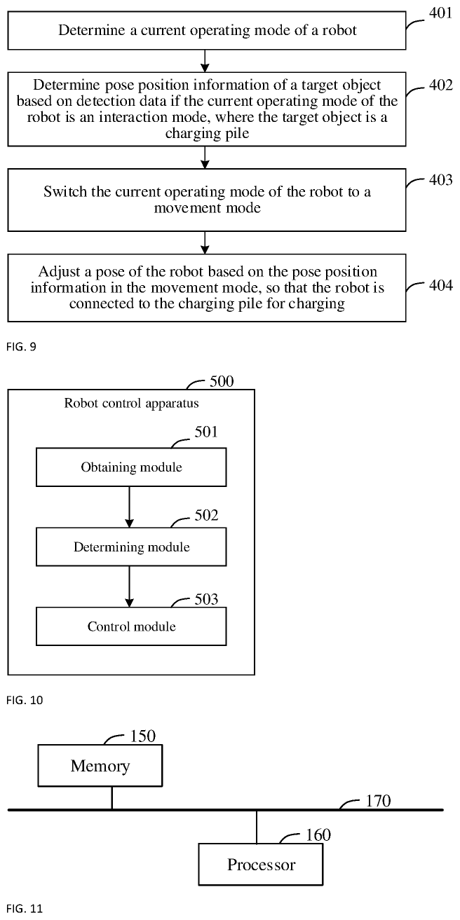

FIG. 10 is a schematic flowchart of a robot control apparatus according to an example embodiment of this application. As shown in FIG. 10, a robot control apparatus 500 provided in this embodiment includes:
an obtaining module 501, configured to determine a current operating mode of a robot, where the operating mode includes a movement mode and an interaction mode, and the robot is configured to move according to a target path in the movement mode and locates a target object in the interaction mode;
a determining module 502, configured to determine a control instruction corresponding to the operating mode based on detection data obtained by a detection sensor, where the detection sensor is arranged on a manipulator mechanism of the robot; and a control module 503, configured to control the robot based on the control instruction.

In a possible design, the determining module 502 is specifically configured to:
determine an obstacle object on the target path based on the detection data if the current operating mode of the robot is the movement mode, where the control instruction is used to control the robot to avoid the obstacle object; or
determine pose position information of the target object based on the detection data if the current operating mode of the robot is the interaction mode, where the control instruction is used to control the robot to take or place the target object.

In a possible design, the control module 503 is further configured to control a detection direction of the detection sensor on the robot to be directed at a current movement direction of the robot.

In a possible design, the determining module 502 is further configured to determine whether the detection direction of the detection sensor is blocked by the robot body.

The control module 503 is further configured to adjust the detection direction of the detection sensor, so that the adjusted detection direction is not blocked by the robot body.

In a possible design, the control module 503 is further configured to control a detection direction of the detection sensor on the robot so that scanning is performed within a preset angle range.

In a possible design, the control module 503 is further configured to determine, based on a detection result after the scanning, that the detection direction of the detection sensor is directed at the target object.

In a possible design, the determining module 502 is specifically configured to:
determine pose position information of the target object based on the detection data if the current operating mode of the robot is the interaction mode, where the target object is a charging pile;
switch the current operating mode of the robot to the movement mode; and
adjust a pose of the robot based on the pose position information in the movement mode, so that the robot is connected to the charging pile for charging.

In a possible design, the manipulator mechanism includes a support, a tray, and a telescopic arm, where the tray is located in the support, the tray is configured for the target object to be placed, the telescopic arm is located on the support, and the telescopic arm is configured to push the target object placed on the tray out of the tray or pull the target object onto the tray;
the detection sensor is arranged below the tray, and is configured to obtain image information of a target position within different image capturing ranges, and the target position includes a position on the target path corresponding to the robot in the movement mode and a taking or placing position of the target object in the interaction mode.

In a possible design, a photographing direction of the detection sensor is the same as a direction of stretching or retracting of the telescopic arm.

In a possible design, the detection sensor is one or more of a visual sensor, an optical sensor, and an acoustic sensor.

It is to be noted that the robot control apparatus provided in this embodiment of this application can perform the robot control method provided in any corresponding embodiment of this application, and has corresponding functional modules and beneficial effects for performing the method.

On the basis of the embodiment shown in FIG. 1, FIG. 11 is a schematic structural diagram of a robot according to another example embodiment of this application. Referring to FIG. 1 and FIG. 11, a robot 100 provided in this embodiment includes
a robot body 100′, a manipulator mechanism 110 arranged on the robot body 100′, a memory 150, a processor 160, and a computer program.

The manipulator mechanism 110 is configured to transport a target object, and a detection sensor 1121 is arranged on the manipulator mechanism 110.

The memory 150 is configured to store computer-executable instructions.

The computer program is stored in the memory 150, and configured to be executed by the processor 160 to implement the robot control method provided in any of the embodiments corresponding to FIG. 6 to FIG. 9 of this application.

The memory 150 and the processor 160 are connected through a bus 170.

The computer-readable storage medium may be a ROM, a random access memory (RAM), a CD-ROM, a magnetic tape, a floppy disk, an optical data storage device, and the like.

An embodiment of this application further provides a program product. The program product includes executable instructions stored in a readable storage medium. At least one processor of a robot may read the executable instructions from the readable storage medium, and the at least one processor executes the executable instructions, so that a shelving unit scheduling apparatus implements the robot control method provided in the above various implementations.

In the several embodiments provided in this application, it should be understood that the disclosed device and method may be implemented in other manners. For example, the device embodiments described above are merely exemplary. For example, division of modules is merely logical function division and may be other division manners during actual implementation. For example, a plurality of modules may be combined or integrated into another system, or some features may be omitted or not executed. In addition, the displayed or discussed mutual coupling or direct coupling or communication connections may be implemented by some interfaces. The indirect coupling or communication connection between the apparatuses or modules may be electrical, mechanical, or in other forms.

The modules described as separate components may or may not be physically separated, and the components displayed as modules may or may not be physical units, which may be located in one place or may be distributed on a plurality of network units. Some or all of the modules may be selected according to actual needs to achieve the objectives of the solutions of the embodiments.

In addition, functional modules in the embodiments of this application may be integrated into one processing unit, or each module may exist alone physically, or two or more modules may be integrated into one unit. The unit integrated by the modules may be implemented in the form of hardware, or may be implemented in the form of hardware and a software function unit.

The above integrated module in the form of software functional modules may be stored in one computer-readable storage medium. The software function module is stored in a storage medium and includes several instructions for causing a computer device (which may be a personal computer, a server, a network device, or the like) or a processor to perform some steps of the method described in the embodiments of this application.

It should be understood that the processor may be a central processing unit (Central Processing Unit, CPU for short), and may further be other general-purpose processors, a digital signal processor (Digital Signal Processor, DSP for short), an application specific integrated circuit (Application Specific Integrated Circuit, ASIC for short), and the like. The general-purpose processor may be a microprocessor, or the processor may be any conventional processor or the like. The steps of the methods disclosed with reference to the present invention may be directly performed by a hardware processor, or may be performed by using a combination of hardware and software modules in the processor.

The memory may include a high-speed RAM memory, or may include a non-volatile storage NVM, for example, at least one disk memory, a USB flash disk, a mobile hard disk drive, a read-only memory, a magnetic disk, an optical disc, or the like.

The bus may be an industry standard architecture (Industry Standard Architecture, ISA for short) bus, a peripheral component interconnect (Peripheral Component, PCI for short) bus, or an extended industry standard architecture (Extended Industry Standard Architecture, EISA for short) bus, and the like. The bus may be classified as an address bus, a data bus, a control bus, or the like. For ease of representation, the bus in the accompanying drawings of this application is not limited to only one bus or one type of bus.

The storage medium may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disc, or an optical disc. The storage medium may be any available medium accessible to a general-purpose or dedicated computer.

For example, a storage medium is coupled to a processor, so that the processor can read information from the storage medium or write information into the storage medium. Certainly, the storage medium may be a component of the processor. The processor and the storage medium may be located in the application specific integrated circuit (ASIC). Certainly, the processor and the storage medium may also exist in an electronic device or a master device as discrete components.

A person of ordinary skill in the art may understand that all or some of the steps of the method embodiments may be performed by a program instructing relevant hardware. The program may be stored in a computer-readable storage medium. When the program is executed, steps of the foregoing method embodiments are performed. The storage medium described above includes: various media such as a ROM, a RAM, a magnetic disk, an optical disk, or the like that can store program code.

Finally, it should be noted that: the foregoing embodiments are merely used for describing the technical solutions of this application, but are not intended to limit this application. Although this application is described in detail with reference to the foregoing embodiments, it should be appreciated by a person skilled in the art that, modifications may still be made to the technical solutions described in the foregoing embodiments, or equivalent replacements may be made to some or all of the technical features. However, these modifications or replacements do not cause the essence of corresponding technical solutions to depart from the scope of the technical solutions in the embodiments of this application.

1. A robot control method, applicable to a robot, wherein the robot comprises a robot body and a manipulator mechanism arranged on the robot body, the manipulator mechanism is configured to transport a target object, and a detection sensor is arranged on the manipulator mechanism, the method comprising:
determining a current operating mode of the robot, wherein the operating mode comprises a movement mode and an interaction mode, and the robot is configured to move according to a target path in the movement mode and locate the target object in the interaction mode;
determining a control instruction corresponding to the operating mode based on detection data obtained by the detection sensor; and
controlling the robot based on the control instruction.

2. The robot control method according to claim 1, wherein the determining a control instruction corresponding to the operating mode based on detection data obtained by the detection sensor comprises:
determining an obstacle object on the target path based on the detection data if the current operating mode of the robot is the movement mode, wherein the control instruction is used to control the robot to avoid the obstacle object; or
determining pose position information of the target object based on the detection data if the current operating mode of the robot is the interaction mode, wherein the control instruction is used to control the robot to take or place the target object.

3. The robot control method according to claim 2, wherein if the current operating mode of the robot is the movement mode, the method further comprises:
controlling a detection direction of the detection sensor on the robot to be directed at a current movement direction of the robot.

4. The robot control method according to claim 3, wherein after the controlling a detection direction of the detection sensor on the robot to be directed at a current movement direction of the robot, the method further comprises:
determining whether the detection direction of the detection sensor is blocked by the robot body; and
adjusting the detection direction of the detection sensor if the detection direction is blocked, so that the adjusted detection direction is not blocked by the robot body.

5. The robot control method according to claim 2, wherein if the current operating mode of the robot is the interaction mode, the method further comprises:
controlling a detection direction of the detection sensor on the robot so that scanning is performed within a preset angle range; and
determining, based on a detection result after the scanning, that the detection direction of the detection sensor is directed at the target object.

6. The robot control method according to claim 1, wherein the determining a control instruction corresponding to the operating mode based on detection data obtained by the detection sensor comprises:
determining pose position information of the target object based on the detection data if the current operating mode of the robot is the interaction mode, wherein the target object is a charging pile;
switching the current operating mode of the robot to the movement mode; and
adjusting a pose of the robot based on the pose position information in the movement mode, so that the robot is connected to the charging pile for charging.

7. The robot control method according to claim 1, wherein the manipulator mechanism comprises a support, a tray, and a telescopic arm, wherein the tray is located in the support, the tray is configured for the target object to be placed, the telescopic arm is located on the support, and the telescopic arm is configured to push the target object placed on the tray out of the tray or pull the target object onto the tray; and
the detection sensor is arranged below the tray, and is configured to obtain image information of a target position within different image capturing ranges, and the target position comprises: a position on the target path corresponding to the robot in the movement mode and a taking or placing position of the target object in the interaction mode.

8. The robot control method according to claim 7, wherein a photographing direction of the detection sensor is the same as a direction of stretching or retracting of the telescopic arm.

9. The robot control method according to claim 8, wherein the detection sensor is one or more of a visual sensor, an optical sensor, and an acoustic sensor.

10. A robot, comprising: a robot body, a manipulator mechanism arranged on the robot body, a memory, and at least one processor, wherein
the manipulator mechanism is configured to transport a target object, and a detection sensor is arranged on the manipulator mechanism;
the memory is configured to store computer-executable instructions; and
the at least one processor executes the computer-executable instructions stored in the memory, so that the at least one processor performs the robot control method according to claim 1.

11. A non-transitory computer-readable storage medium, storing computer-executable instructions, wherein when a processor executes the computer-executable instructions, the robot control method according to claim 1 is implemented.
